(19) United States
(12) Patent Application Publication
(10) Pub. No.: US 2018/0164809 A1
(43) Pub. Date: Jun. 14, 2018

(54) Autonomous School Bus

(71) Applicant: Ford Global Technologies, LLC, Dearborn, MI (US)

(72) Inventors: Maryam Moosaei, Mishawaka, IN (US); Madeline J. Goh, Palo Alto, CA (US); Guy Hotson, Palo Alto, CA (US)

(21) Appl. No.: 15/373,996

(22) Filed: Dec. 9, 2016

(51) Int. Cl. G05D 1/00; G05D 1/02

(52) U.S. Cl. CPC G05D 1/0088; G05D 1/0246; G05D 1/0022; G05D 1/0257; G05D 1/0255

(57) ABSTRACT

An autonomous bus includes sensors and actuators sufficient to perform autonomous navigation. The controller of the bus receives a route and proceeds to pick-up locations along the route. A camera having an external region around a door in its field of view evaluates whether an individual matching recognition information of an intended passenger is present. If so, a door actuator permits entry of the individual and entry of the individual is verified. If the individual does not enter or another individual enters, an alert may be generated and the controller may refrain from moving. During transit noise levels and levels of stress chemicals may be monitored. Where noise or stress chemicals indicate a problem, an alert may be generated.

### BACKGROUND

### Field of the Invention

This invention relates to incorporating human control inputs into autonomous vehicle operation.

### Background of the Invention

An autonomous vehicle can be used as a school bus for moving students between home and school or on fieldtrips or other outings. Due to the increased concerns for safety and security whenever working with children or minors, an autonomous school bus requires additional safety and security protocols.

The systems and methods disclosed herein provide an improved approach for implementing an autonomous school bus.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1A is a schematic block diagram of components implementing an autonomous school bus in accordance with an embodiment of the present invention;

FIG. 1B is a schematic block diagram of an autonomous school bus in accordance with an embodiment of the present invention;

FIG. 2 is a schematic block diagram of an example computing device suitable for implementing methods in accordance with embodiments of the invention;

FIG. 3 is a process flow diagram of a method for picking up a passenger using an autonomous school bus in accordance with an embodiment of the present invention; and

FIG. 4 is a process flow diagram of a method for detecting problems during transit of an autonomous school bus in accordance with embodiments of the present invention.

### DETAILED DESCRIPTION

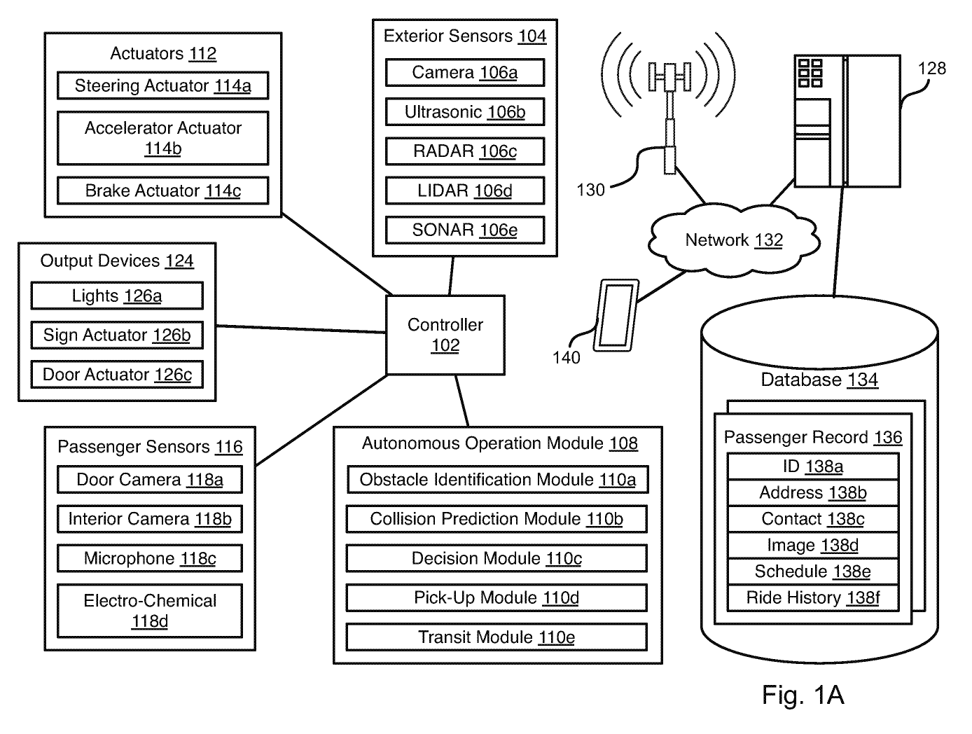

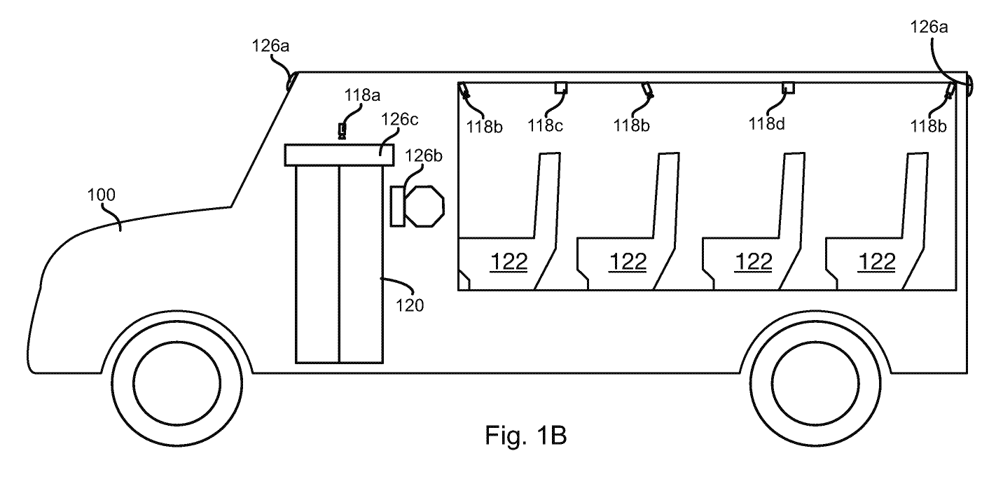

Referring to FIGS. 1A and 1B, a vehicle 100 (see FIG. 1B) may be a large capacity vehicle such as a bus, van, large sport utility vehicle (SUV), or the like. The approach disclosed herein is particularly suitable for picking up minor students using a large capacity vehicle. However, the approach disclosed herein may also be implemented using a smaller capacity vehicle, such as sedan or other small vehicle.

The vehicle 100 may include any vehicle known in the art. The vehicle 100 may have all of the structures and features of any vehicle known in the art including, wheels, a drive train coupled to the wheels, an engine coupled to the drive train, a steering system, a braking system, and other systems known in the art to be included in a vehicle.

As discussed in greater detail herein, the controller 102 may perform autonomous navigation and collision avoidance. The controller 102 may receive one or more outputs from one or more exterior sensors 104. For example, one or more cameras 106a may be mounted to the vehicle 100 and output image streams received to the controller 102.

The exterior sensors 104 may include sensors such as an ultrasonic sensor 106b, a RADAR (Radio Detection and Ranging) sensor 106c, a LIDAR (Light Detection and Ranging) sensor 106d, a SONAR (Sound Navigation and Ranging) sensor 106e, and the like.

The controller 102 may execute an autonomous operation module 108 that receives the outputs of the exterior sensors 104. The autonomous operation module 108 may include an obstacle identification module 110a, a collision prediction module 110b, and a decision module 110c. The obstacle identification module 110a analyzes the outputs of the exterior sensors and identifies potential obstacles, including people, animals, vehicles, buildings, curbs, and other objects and structures. In particular, the obstacle identification module 110a may identify vehicle images in the sensor outputs.

The collision prediction module 110b predicts which obstacle images are likely to collide with the vehicle 100 based on its current trajectory or current intended path. The collision prediction module 110b may evaluate the likelihood of collision with objects identified by the obstacle identification module 110a. The decision module 110c may make a decision to stop, accelerate, turn, etc. in order to avoid obstacles. The manner in which the collision prediction module 110b predicts potential collisions and the manner in which the decision module 110c takes action to avoid potential collisions may be according to any method or system known in the art of autonomous vehicles.

The decision module 110c may control the trajectory of the vehicle by actuating one or more actuators 112 controlling the direction and speed of the vehicle 100. For example, the actuators 112 may include a steering actuator 114a, an accelerator actuator 114b, and a brake actuator 114c. The configuration of the actuators 114a-114c may be according to any implementation of such actuators known in the art of autonomous vehicles.

In embodiments disclosed herein, the autonomous operation module 108 may perform autonomous navigation to a specified location, autonomous parking, and other automated driving activities known in the art.

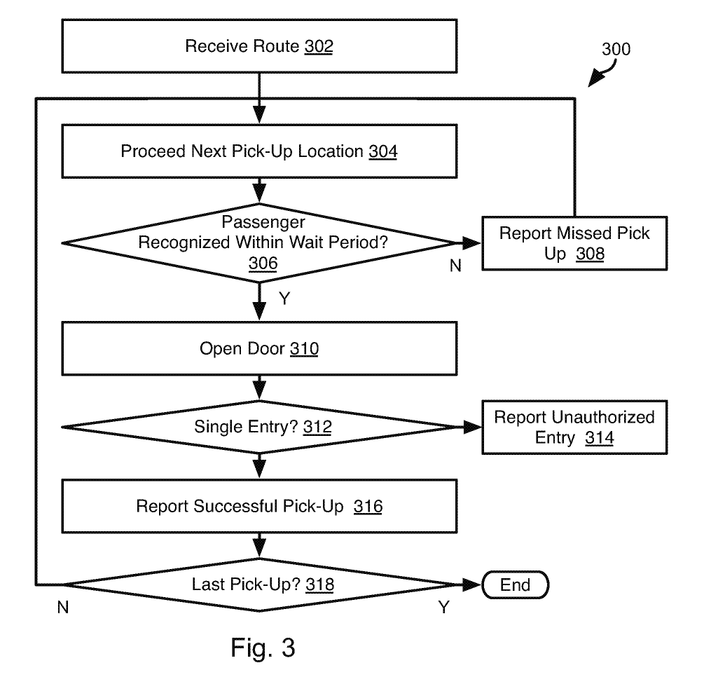

The autonomous operation module 108 may operate to pick up, transport, and drop off minor children or passengers that may otherwise require oversight during transportation. To that end, the autonomous operation 108 may include a pick-up module 110d. The pick-up module 110d verifies entry of passengers and detects entry of unauthorized individuals. In particular, the pick-up module 110d may execute the method 300 of FIG. 3.

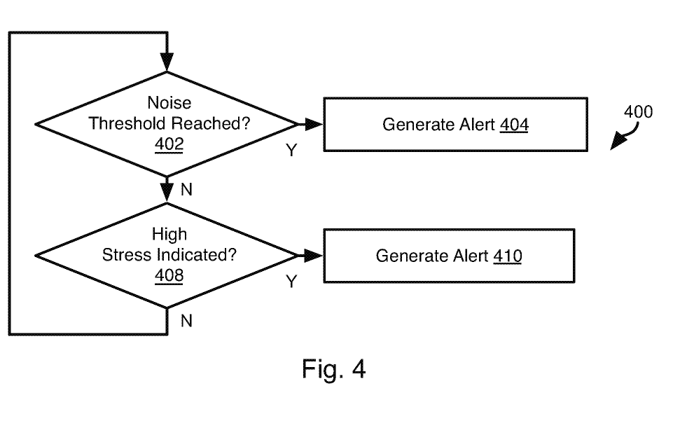

The autonomous operation module 108 may further include a transit module 110e that detects problems during transit of the passengers. The operation of the transit module 110e is described below with respect to the method 400 of FIG. 4.

The pick-up module 110d and transit module 110e may operate with respect to outputs of one or more passenger sensors 116. The passenger sensors 116 may include a door camera 118a. The door camera 118a is positioned internally or externally such that the door camera 118a has in a field of view thereof a region extending up to and possibly including a door 120. In this manner, a passenger standing outside the door 120 may be identified.

The passenger sensors 116 may further include one or more interior cameras 118b. The interior cameras 118b may have seats 122 of the vehicle 100 in the fields of view thereof. The passenger sensors 116 may further include sensors such as one or more microphones 118c and an electro-chemical sensor 118d.

The vehicle 100 may further include one or more output devices 124 coupled to the controller 102. Output devices 124 may include lights 126a for alerting other drivers, a sign actuator 126b for deploying a stop sign, which may also bear lights 126a, and a door actuator 126c. In embodiments where the vehicle 100 is a conventional passenger vehicle, the door actuator 126c may be replaced with a lock actuator such that passengers manually open and close the door 120.

The controller 102 may be in data communication with a server system 128. For example, the controller may be in data communication with one or more cellular communication towers 130 that are in data communication with the server system 128 by way of a network 132, such as a local area network (LAN), wide area network (WAN), the Internet, or any other wireless or wired network connection.

The server system 128 may host or access a database 134. The database 134 may store a plurality of passenger records 136 for individuals that are to be transported using the vehicle 100. The passenger records 136 may include such information such as an identifier 138a of the passenger, a pick-up address 138b of the passenger, contact information 138c for a guardian of the passenger, and an image 138d or other identification information for the passenger. In particular, the image 138d may include an image or information derived from an image of the passenger that may be used for facial recognition. The passenger record 136 may further include a schedule 138e of days and or time windows in which the passenger is to be picked up and the locations at which the passenger is to be picked up. The schedule 138e may further list a destination for each scheduled pick up. The passenger record 136 may store a ride history 138f listing information regarding previous rides given to the passenger, such as actual pick up and drop off times, and the like.

The contact information 138c may refer to a mobile device 140 of the guardian, such as phone number. The contact information 138c may reference a user identifier for an application executing on the mobile device 140. The contact information may further include an email address or other contact information.

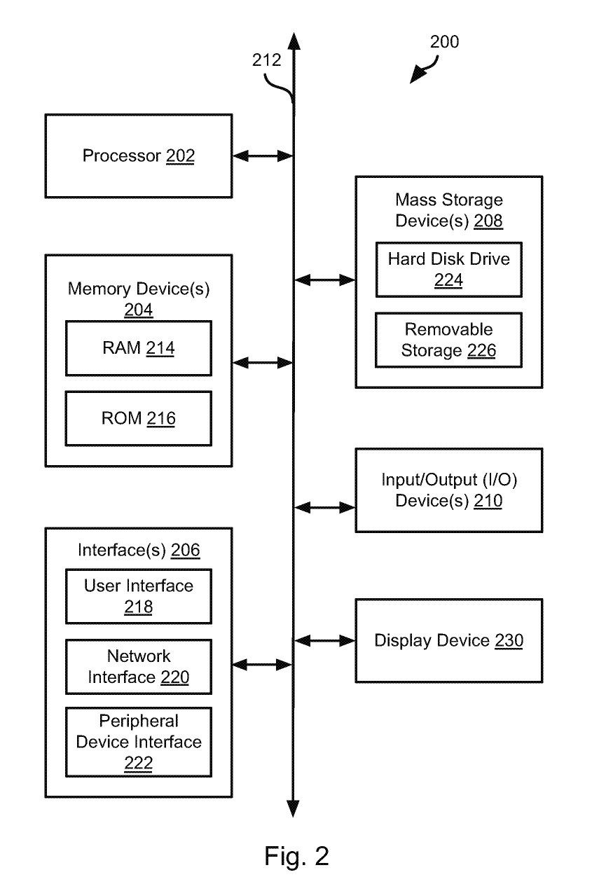

FIG. 2 is a block diagram illustrating an example computing device 200. Computing device 200 may be used to perform various procedures, such as those discussed herein. The controller 102, server system 128, and mobile device 140 may have some or all of the attributes of the computing device 200.

Computing device 200 includes one or more processor(s) 202, one or more memory device(s) 204, one or more interface(s) 206, one or more mass storage device(s) 208, one or more Input/Output (I/O) device(s) 210, and a display device 230 all of which are coupled to a bus 212. Processor(s) 202 include one or more processors or controllers that execute instructions stored in memory device(s) 204 and/or mass storage device(s) 208. Processor(s) 202 may also include various types of computer-readable media, such as cache memory.

Memory device(s) 204 include various computer-readable media, such as volatile memory (e.g., random access memory (RAM) 214) and/or nonvolatile memory (e.g., read-only memory (ROM) 216). Memory device(s) 204 may also include rewritable ROM, such as Flash memory.

Mass storage device(s) 208 include various computer readable media, such as magnetic tapes, magnetic disks, optical disks, solid-state memory (e.g., Flash memory), and so forth. As shown in FIG. 2, a particular mass storage device is a hard disk drive 224. Various drives may also be included in mass storage device(s) 208 to enable reading from and/or writing to the various computer readable media. Mass storage device(s) 208 include removable media 226 and/or non-removable media.

I/O device(s) 210 include various devices that allow data and/or other information to be input to or retrieved from computing device 200. Example I/O device(s) 210 include cursor control devices, keyboards, keypads, microphones, monitors or other display devices, speakers, printers, network interface cards, modems, lenses, CCDs or other image capture devices, and the like.

Display device 230 includes any type of device capable of displaying information to one or more users of computing device 200. Examples of display device 230 include a monitor, display terminal, video projection device, and the like.

Interface(s) 206 include various interfaces that allow computing device 200 to interact with other systems, devices, or computing environments. Example interface(s) 206 include any number of different network interfaces 220, such as interfaces to local area networks (LANs), wide area networks (WANs), wireless networks, and the Internet. Other interface(s) include user interface 218 and peripheral device interface 222. The interface(s) 206 may also include one or more peripheral interfaces such as interfaces for printers, pointing devices (mice, track pad, etc.), keyboards, and the like.

Bus 212 allows processor(s) 202, memory device(s) 204, interface(s) 206, mass storage device(s) 208, I/O device(s) 210, and display device 230 to communicate with one another, as well as other devices or components coupled to bus 212. Bus 212 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 200, and are executed by processor(s) 202. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

Referring to FIG. 3, the illustrated method 300 may be executed by the controller 102 in order to pick up a plurality of passengers. The method 300 may include receiving 302 a route from the server system 128. The route may be an ordering of pick-up locations of passengers. The ordering may be determined to reduce the distance traveled. For example, the server system 128 may distribute pick-up locations among routes and order pick-up locations within a route according to a solution of the so-called “traveling salesman problem” using any approach to solving this problem as known in the art. The route as received from the server system 128 may include a target time or time window in which each passenger should be picked up.

The method 300 may include proceeding 304 a next pick-up location from the route, starting at the first pick-up location. This may include autonomously navigating to the next pick-up location from the vehicle's 100 current location. Upon arriving at the pick-up location the controller 102 may activate the lights 126a and sign actuator 126b. The method 300 may include evaluating 306 whether the passenger corresponding to the pick-up location is recognized within a wait period from the time of arrival at the pick-up location, or within a wait period from a target arrival time at the pick-up location. Evaluating whether the passenger is recognized may include evaluating 306 whether a person corresponding to the recognition information 138d for the passenger is present in the output of the door camera 118a. This may include performing facial recognition on the output of the door camera 118a.

If not, then the method 300 may include reporting 308 a missed pick up. This may include transmitting a notification to the guardian of the passenger using the contact information 138c. A notification may also be sent to the server system 128. The method 300 may then continue at step 304 for the next pick-up location.

If the passenger is found 306 to be recognized within the wait period, the controller 102 may then open 310 the door 120, such as using the door actuator 126c. Where the door 120 is not self-actuated, step 310 may include unlocking the door 120.

The method 300 may include evaluating 312 whether a single passenger entered while the door was opened at step 312. This may include evaluating the output of one or both of the door camera 118a and an interior camera 118b. Step 312 may include identifying movement of individuals in the output of one or more cameras and determining whether a single individual entered the vehicle. In some embodiments, step 312 may include evaluating whether an individual who actually entered the vehicle has the same facial recognition attributes as the passenger.

If single entry 312 is not found, i.e. no one entered, multiple people entered, or the individual who entered the vehicle does not match the passenger corresponding to the pick-up location, the method 300 may include reporting 314 unauthorized entry into the vehicle 100. The vehicle 100 may be prevented from moving until the alert is resolved. For example, the method 300 may not proceed to step 304 for the next pick-up location until an operator manually invokes restarting of the process 300 following the report 314.

If the passenger is determined 312 to have entered alone into the vehicle 100 at step 312, then successful pick-up of the passenger may be reported 316 and the door actuator 126c may then close the door 120. The controller 102 may also deactivate the lights 126a and cause the sign actuator 126b to retract the sign. The report may be transmitted to the guardian of the passenger and may further be reported to the server system 124 and stored in the ride history 138f of the passenger. If the passenger is found 318 to be the last passenger in the route, then the method ends. Otherwise, the method continues at step 304 for the next pick-up location.

Referring to FIG. 4, the illustrated method 400 may be executed by the controller 102 throughout traversal of a route. The method 400 may include evaluating an output of the microphone 118c. Noise above the threshold corresponding to the number of passengers in the vehicle 100 may indicate a commotion or distress within the vehicle 100. The threshold used may increase with the number of passengers. If the output of the microphone 118c indicates that noise within the vehicle 100 exceeds the threshold, an alert may be generated 404. This may include transmitting the alert to the server system 128 and/or the guardians of all passengers currently aboard the vehicle 100.

The method 400 may include evaluating 408 an output of the electro-chemical sensor 118d. Stress in a human triggers the release of pheromones and other chemicals. An output of the electro-chemical sensor 118d may be evaluated 408 to determine whether the signature of stress-indicating chemicals is detected and whether the output of the sensor 118d indicates a concentration of these chemicals that is above a threshold for a given number of passengers, where the threshold increases with the number of passengers. In this manner, events that occur in the vehicle 100 that cause a high level of fear or stress will result in generation 410 of alert. This may include transmitting the alert to the server system 128 and/or the guardians of all passengers currently aboard the vehicle 100. The server system 128 may present these alerts to human operators that may view outputs of the interior cameras 118b and microphone 118c and invoke actions by the controller 102 such as stopping, proceeding to a police station or other safe location, or other actions. The remote operators may also verify that conditions are normal and invoke continued proceeding along the route.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

1. A method comprising, by a controller of an autonomous vehicle:
receiving an instruction to proceed to a pick-up location with recognition information;
causing the autonomous vehicle to proceed to the pick-up location;
detecting (a) a passenger corresponding to the recognition information in an output of a first camera mounted to the autonomous vehicle; and
in response to (a), permitting entry of the passenger and proceeding to a destination.

2. A method of claim 1, further comprising:
detecting (b) entry of the passenger into the vehicle using at least one of the first camera and a second camera, a field of view of the second camera including an interior of the vehicle; and
in response to (b), transmitting a notification to a guardian of the passenger.

3. A method of claim 1, further comprising:
detecting at least one of:
(b) entry of the passenger and an additional individual into the vehicle using at least one of the first camera and a second camera, a field of view of the second camera including an interior of the vehicle; and
(c) detecting entry of a person that does not correspond to the recognition information into the vehicle using at least one of the first camera and the second camera;
in response to detecting at least one of (b) and (c), transmitting an alert and refraining from departing from the pick-up location.

4. The method of claim 1, wherein permitting entry of the passenger comprises activating a door actuator.

5. The method of claim 1, wherein detecting (a) comprises performing facial recognition with respect to an output of the first camera using the recognition information.

6. The method of claim 1, further comprising automatically deploying a stop sign upon arriving at the pick-up location.

7. The method of claim 1, wherein receiving the instruction to proceed to the pick-up location comprises receiving a route including a plurality of pick-up locations including the pick-up location, the method further comprising proceeding to each of the pick-up locations of the plurality of pick-up locations.

8. The method of claim 7, further comprising:
autonomously driving to a second pick-up location of the plurality of pick-up locations;
detecting (b) expiration of a time period without detecting a second passenger corresponding to second recognition information corresponding to the second pick-up location; and
in response to detecting (b), transmitting an alert to a guardian of the second passenger.

9. The method of claim 8, further comprising in response to detecting (b), proceeding to a next pick-up location of the plurality of pick-up locations.

10. The method of claim 1, wherein the vehicle is an autonomous bus.

11. An autonomous vehicle comprising:
a first camera;
a door actuator;
a controller coupled to the first camera and the door actuator, the controller programmed to:
receive an instruction to proceed to a pick-up location with recognition information;
cause the autonomous vehicle to proceed to the pick-up location;
if a passenger corresponding to the recognition information in an output of a first camera mounted to the autonomous vehicle, cause the door actuator to permit entry of the passenger and proceeding to a destination.

12. The autonomous vehicle of claim 11, wherein the controller is further programmed to:
evaluate an output of at least one of the first camera and the second camera, a field of view of the second camera including an interior of the vehicle; and
if entry of the passenger into the vehicle is apparent in the output, transmit a notification to a guardian of the passenger.

13. The autonomous vehicle of claim 11, wherein the controller is further programmed to:
evaluate whether an output of at least one of the first camera and a second camera indicates at least one of (a) entry of the passenger and an additional individual into the vehicle and (b) entry of a person that does not correspond to the recognition information into the vehicle;
if the output indicates at least one (a) and (b), transmit an alert and refrain from departing from the pick-up location.

14. The autonomous vehicle of claim 11, wherein the controller is further programmed to evaluate whether the passenger corresponds to the recognition information by performing facial recognition with respect to an output of the first camera using the recognition information.

15. The autonomous vehicle of claim 11, further comprising a sign actuator, the controller automatically activating the sign actuator in response to arriving at the pick-up location.

16. The autonomous vehicle of claim 11, wherein the controller is further programmed to receive the instruction to proceed to the pick-up location by receiving a route including a plurality of pick-up locations including the pick-up location.

17. The autonomous vehicle of claim of claim 11, wherein the vehicle controller is further programmed to:
evaluate whether (a) expiration of a time period has occurred without detecting an individual corresponding to the recognition information; and
if (a), transmit an alert to a guardian of the second passenger.

18. The autonomous vehicle of claim 17, wherein the vehicle controller is further programmed to:
if (a), proceed to a next pick-up location.

19. The autonomous vehicle of claim 11, wherein the vehicle is an autonomous bus.

20. The autonomous vehicle of claim 19, further comprising:
a plurality of external sensors including at least one of a camera, a light detection and ranging (LIDAR) sensor, and a radio detection and ranging (RADAR) sensor; and
a plurality of actuators including a brake actuator, steering actuator, and accelerator actuator;
wherein the controller is programmed autonomously drive the vehicle by activating the plurality of actuators in accordance with outputs of the plurality of external sensors.
